(19) United States
(12) Patent Application Publication
(10) Pub. No.: US 2013/0206694 A1
(43) Pub. Date: Aug. 15, 2013

(54) MEMBRANE FOR WATER PURIFICATION

(71) Applicant: King Abdullah University of Science and Technology, (US)

(72) Inventors: Suzana Pereira NUNES, Thuwal (SA); Husnul MAAB, Thuwal (SA); Lijo FRANCIS, Thuwal (SA)

(73) Assignee: KING ABDULLAH UNIVERSITY OF SCIENCE AND TECHNOLOGY, Thuwal (SA)

(21) Appl. No.: 13/765,228

(22) Filed: Feb. 12, 2013

Related U.S. Application Data
(60) Provisional application No. 61/598,334, filed on Feb. 13, 2012.
(60) Provisional application No. 61/717,928, filed on Oct. 24, 2012.

(51) Int. Cl. C02F 1/44

(52) U.S. Cl. CPC C02F 1/44
USPC 210/650; 210/500.28; 210/500.23; 264/465; 521/189

(57) ABSTRACT

A porous membrane can include a polyazole.

### CLAIM FOR PRIORITY

This application claims priority to U.S. Patent Application No. 61/598,334, filed Feb. 13, 2012, and U.S. Patent Application 61/717,928, filed Oct. 24, 2012, each of which is hereby incorporated by reference in its entirety.

### TECHNICAL FIELD

This invention relates to a membrane for water purification.

### BACKGROUND OF THE INVENTION

Water can be purified by passing through membranes using a variety of methods.

### SUMMARY

In one aspect, a membrane for fluid purification includes a polyazole polymer. The polyazole polymer can include a polyoxadiazole or polytriazole, or a copolymer thereof.

In certain embodiments, the polymer can include repeating units:

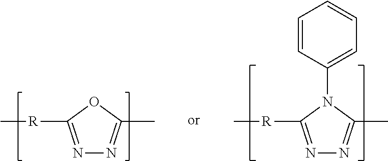

or their copolymers, where R is,

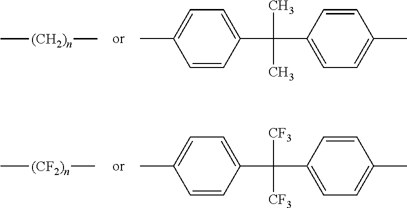

in which n is an integer from 1-8.

The membrane can be a flat sheet, hollow fiber or electrospun.

The membrane can be used in a system for purifying water. For example, a method of purifying water can include passing water through the membrane.

A method of forming the membrane can include dissolving the polymer in an organic solvent and casting the membrane, where the method of casting the membrane includes phase inversion or electrospinning.

Other aspects, embodiments, and features will be apparent from the following description, the drawings, and the claims.

### DETAILED DESCRIPTION OF THE DRAWINGS

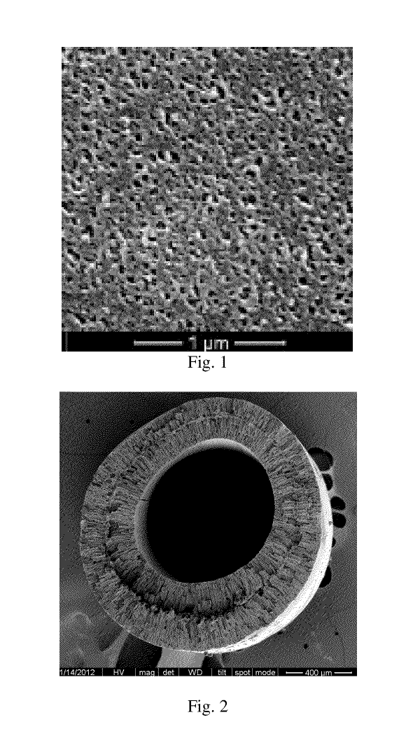

FIG. 1 is a micrograph depicting a hydrophobic porous membrane prepared by phase inversion from fluorinated polyoxadiazole.

FIG. 2 is a micrograph depicting a hydrophobic porous membrane prepared by phase inversion in a hollow fiber machine from fluorinated polyoxadiazole.

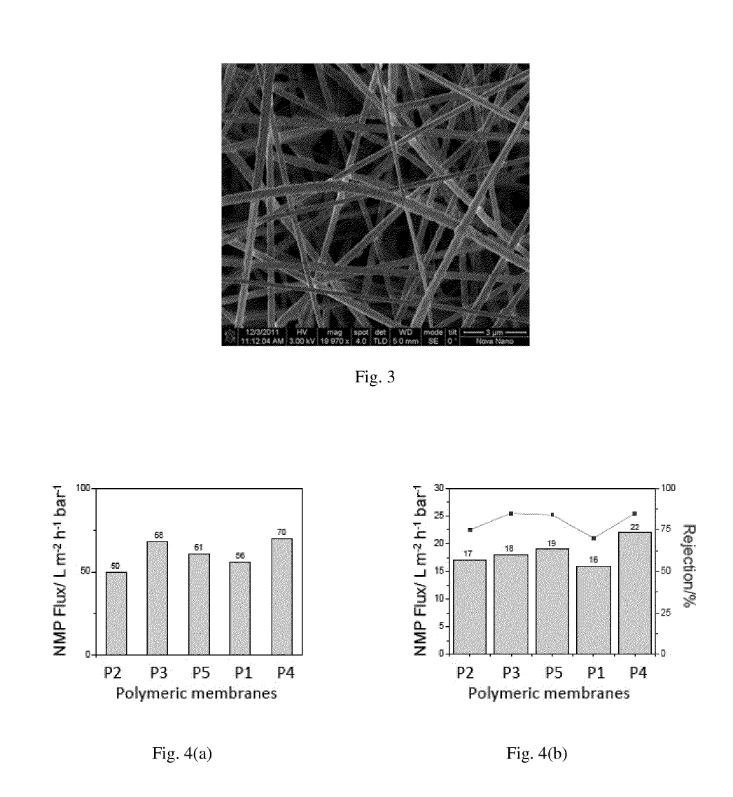

FIG. 3 is a micrograph depicting a hydrophobic porous membrane prepared by electrospinning from fluorinated polyoxadiazole.

FIG. 4(a) depicts the flux of brilliant blue in N-methylpyrrolydone through five polyazole membranes, each with a different R group.

FIG. 4(b) depicts the rejection of brilliant blue in N-methylpyrrolydone through five polyazole membranes, each with a different R group.

### DETAILED DESCRIPTION OF THE INVENTION

Polymers have been prepared including polyazole monomeric units, which can be used to form a porous membrane for membrane distillation. In particular, the polymers are based on polyazole polymers having hydrophobic groups. Exemplary polymers include compositions including the repeating units:

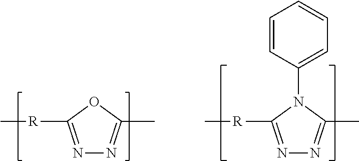

or their copolymers, where R is, for example,

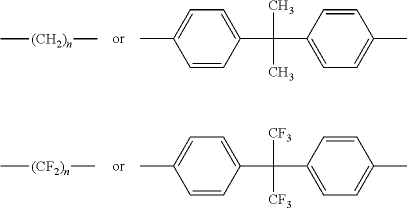

in which n is an integer from 1-8. R could also be another hydrophobic group. For example, a copolymer can be prepared with R being

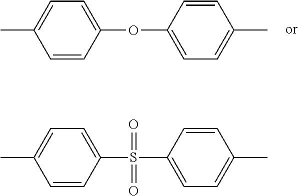

Membranes prepared from the above molecules can be stable at temperatures higher than 200° C. The hydrophobic segments enhance the suitability of the membrane for membrane distillation.

The polymers are prepared following a known procedure for dense membranes for fuel cell application. (See, for example, D. Gomes, S. P. Nunes, Fluorinated polyoxadiazole for high-temperature polymer electrolyte membrane fuel cell, J. Membrane Sci. 321 (1) (2008) 114-122; M. Ponce, D. F. Gomes, S, Nunes, V. Abetz, Manufacture of a functionalized polytriazole polymer, US20080182964 A1 (2008); D. F. Gomes, J. Roeder Jesus, S, Nunes, Method for production of a sulfonated poly(1,3,4-oxadiazole) polymer, US20080318109 A1 (2008); M. L. Ponce, J. Roeder, D. Gomes and S. P. Nunes, Stability and Proton Conductivity of Sulfonated Polytriazole and Polyoxadiazole Membranes, Asia Pacific J. Chemical Engineering, 5 (1) (2010) 235-241, each of which is incorporated by reference in its entirety.) Other polyoxadiazoles have been reported by other authors (See D. F. Gomes, M. R. Loos, Method for the Synthesis of a Polyoxadiazole Polymer, US7847054 (2010); M. R. Loos, V. Abetz, K. Schulte, Polyoxadiazole Polymers, EP2241585 (A1) (2010), each of which is incorporated by reference in its entirety). The polymers can be blended, for example, with a polysulfone, a polyetherimide, one or more fluorinated additives, or have modified surfaces.

The polymers with the composition shown above are dissolved in a suitable solvent, for example, an organic solvent (e.g., dimethylformamide, dimethylacetamide, or dimethylsulfoxide), to form a casting solution. The casting solution is used for manufacture of porous membranes by phase inversion, consisting of casting the polymer in the form of a flat sheet (as shown in FIG. 1), a hollow fiber (as shown in FIG. 2) and immersion in water or by electrospinning (as shown in FIG. 3). Porous membranes have been prepared by phase separation from polyvinylfluoride, which is not as hydrophobic as the polymers described herein.

The polymer membranes can be used in membrane distillation, which is an emerging technology for water desalination and reuse with low energy consumption. A review of this technology has been recently published, which reviews various membranes for membrane distillation, but does not include any based on polyazole. (See M. Khayet, Adv. Colloid Int. Sci., 164 (2011) 56, which is incorporated by reference in its entirety.) In particular, the membranes can be used for desalination or water reuse. In some circumstances, the water purification can include brine desalination. In particular, the polyazole polymer can be a polyoxadiazole or polytriazole, or a copolymer thereof.

Advantages of the developed polymer membranes include the high thermal stability of the membranes, high hydrophobicity, and high porosity. For example, the polymer membranes can be stable at temperatures up to 300° C. The high hydrophobicity membranes can have a high water-surface contact angle.

Other membranes for membrane distillation have been reported based on polypropylene or semicrystalline polytetrafluorethylene. (See M. Khayet, Adv. Colloid Int. Sci., 164 (2011) 56, which is incorporated by reference.) These membranes have been prepared by other methods (e.g., extrusion). They are hydrophobic but do not have the high porosity achieved here. Both polypropylene and semicrystalline polytetrafluorethylene can be difficult to dissolve and generally cannot be manufactured into membranes at room temperature as the membranes described here can be. The polymers described here are much more soluble, rendering them suitable for membrane manufacture at room temperature in commercial machines, conventionally used for polysulfone and other polymers traditionally used for ultrafiltration, and other uses.

A membrane with stability in organic solvents can be achieved by the two processes described below.

In one process, polyazoles with very low solubility in regular organic solvents can be obtained by choosing the appropriate R group, examples of which include:

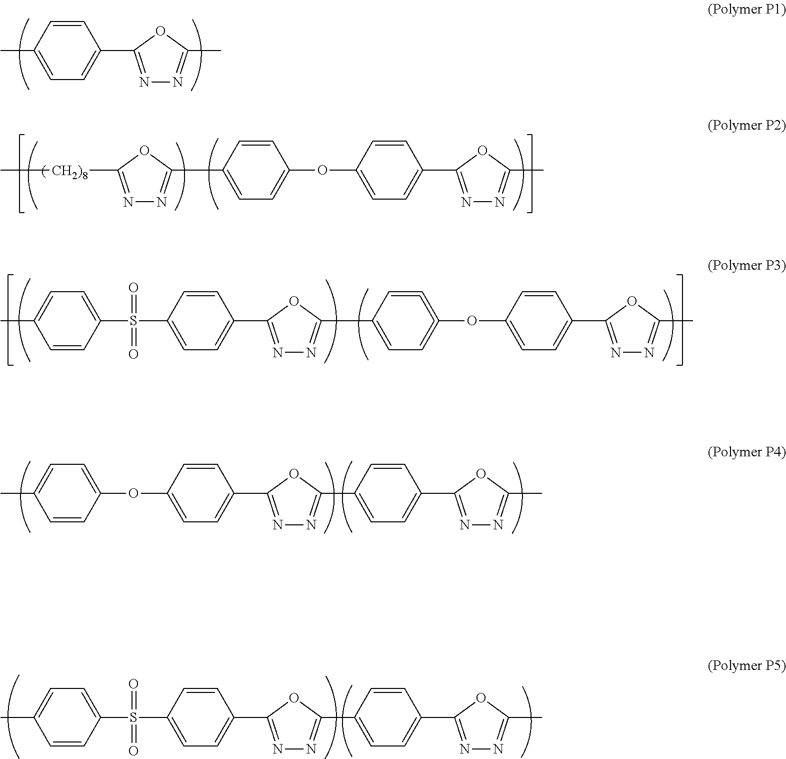

However, these polymers are soluble in strong acids such as sulfuric acid.

The procedure by which these membranes are manufactured can be conducted by phase inversion with polymer solubilization in acid, casting and immersion in water. By this process, asymmetric porous membranes are obtained, which are hardly soluble in common organic solvents. Water flux as high as 300 L/m²h bar have been confirmed. Flux and rejection of brilliant blue in N-methylpyrrolydone are shown in FIGS. 4(a) and (b).

In another process, an asymmetric porous membrane prepared by phase inversion can be prepared by functionalizing the polytriazole by incorporating R1 anchoring groups for further crosslinking reactions. An example of this is

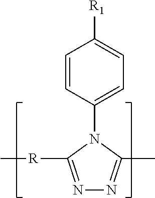

where R1 can be OH, SO₃H, or another reactive group. In this process, the membrane can then be immersed in a solution containing bifunctional molecules which act as crosslinkers, which react with R1 at different temperatures.

An example of a reaction is

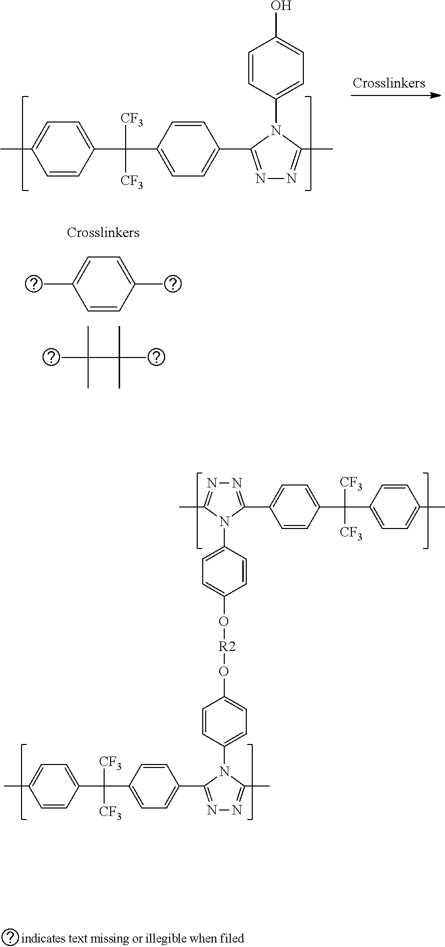

Where R2 can be, for example, —(CH₂)ₙ— (n is 1, 2, 3, 4, 5, 6, 7 or 8) or aryl segments or polyether segments. After functionalization with SO₃H as R1, diamines can be used as crosslinkers.

The polymer or membrane can also be reacted, by hydrolysis in the presence of acids, with dipodal silanes to form bridges between the polymer chains. Examples of dipodal silanes include

(C₂—H₅O)₃Si—(CH₂)₈—Si(C₂—H₅O)₃,

(C₂—H₅O)₃Si-Aryl-Si(C₂H₅O)₃, and

(CH₃O)₃Si—(CH₂)₃—NH—(CH₂)₃—Si(CH₃O)₃.

The polymer or membrane can also be reacted with monofunctionalized silanes instead of dipodal silanes. For example, 3-Glycidoxypropyltrimethoxysilane can be used in the reaction, followed by a reaction with diamine for crosslinking.

The membranes prepared by the two processes above can be applied to water purification containing organic solvents, as well as for purification of solutions prepared in organic solvents (organophilic ultrafiltration). The membranes can also be used as porous support for preparation of composite membranes (e.g., thin-film composite), by coating with organic solutions by a process comprising steps of washing with organic solvents. The membranes can also be used in membrane reactors, requiring operation in the presence of organic solvents and at temperatures as high as 200° C. or even higher.

Membranes have been developed that are suitable for water purification. In particular, hydrophobic membranes have been developed that are suitable for membrane distillation. Membranes have been manufactured and tested for membrane distillation.

Other embodiments are within the scope of the following claims.

What is claimed is:

1. A membrane for fluid purification comprising a polyazole polymer.

2. The membrane of claim 1, wherein the polyazole polymer includes a polyoxadiazole or polytriazole, or a copolymer thereof.

3. The membrane of claim 1, wherein the polyazole polymer includes repeating units: 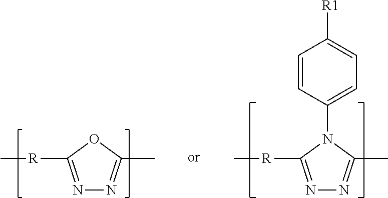
or their copolymers, where R is, 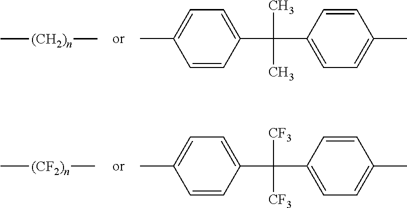
in which n is an integer from 1-8 and R₁ is H or OH, SO₃H, (CH₂)ₙH, triazole, imidazole, tetrazole, CN, CH₂Cl, CH₂Br, CH₂I, SH.

4. The membrane of claim 1, wherein the membrane is a flat sheet, hollow fiber or electrospun.

5. A system for purifying water comprising a membrane of claim 1.

6. A method of purifying water comprising passing water through a membrane of claim 1.

7. A method of forming a membrane of claim 1, comprising dissolving the polymer in an organic solvent and casting the membrane.

8. The method of claim 7 wherein casting the membrane includes phase inversion or electro spinning.

9. The membrane of claim 2, wherein the polyazole polymer includes:

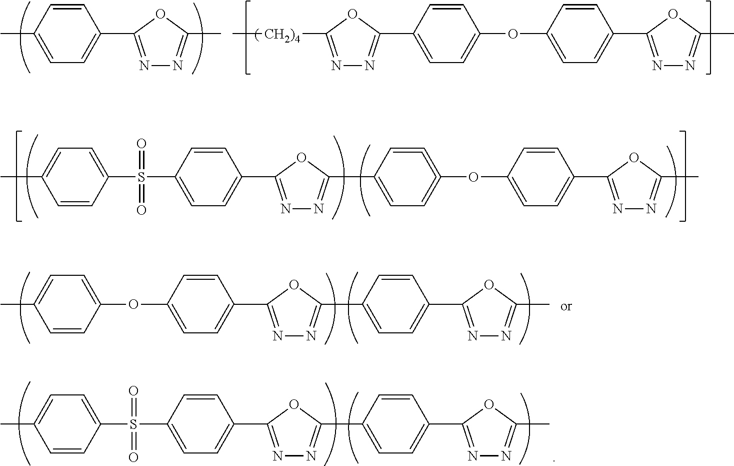

10. A method of forming a membrane of claim 1, comprising polymer solubilization in acid, casting by phase inversion, and immersion in water.

11. A method of forming a membrane of claim 1, comprising functionalizing the polytriazole with R1 anchoring groups, wherein R1 is OH, SO₃H, NH₂, epoxy groups, CH₂—Cl, CH₂Br, CH₂I, aryl-OH, HO—(CH₂)ₙ, SH, CH═CH₂, casting by phase inversion, and wherein the membrane is immersed in a solution comprising crosslinkers, wherein the crosslinkers are bifunctional molecules.

12. A method of forming a membrane of claim 1, comprising the steps of reacting the polymer or membrane by hydrolysis in the presence of acids and dipodal silanes.

13. The method of claim 12, wherein the membrane is immersed in a solution comprising a crosslinker, wherein the crosslinker is a diamine.

14. The method of claim 12, wherein the dipodal silane includes: (C₂H₅O)₃Si—(CH₂)₈—Si(C₂—H₅O)₃; (C₂—H₅O)₃Si-Aryl-Si(C₂H₅O)₃; or (CH₃O)₃Si—(CH₂)₃—NH—(CH₂)₃—Si(CH₃O)₃.

15. A method of forming a membrane of claim 1, comprising the steps of reacting the polymer or membrane by hydrolysis in the presence of acids and a monofunctionalized silane.

16. The method of claim 15, wherein the membrane is immersed in a solution comprising a crosslinker, wherein the crosslinker is a diamine.
